(19) United States
(12) Patent Application Publication
(10) Pub. No.: US 2023/0071288 A1
(43) Pub. Date: Mar. 9, 2023

(54) METHOD AND APPARATUS FOR CONTACTLESS MEASURING OF AN OBJECT SURFACE

(71) Applicants: Fraunhofer-Gesellschaft zur Förderung der angewandten Forschung e.V., München (DE); FRIEDRICH-SCHILLER-UNIVERSITÄT JENA, Deutschland (DE)

(72) Inventors: Martin Landmann, Jena (DE); Patrick Dietrich, Jena (DE); Stefan Heist, Jena (DE); Peter KÜHMSTEDT, Jena (DE); Gunther Notni, Jena (DE)

(21) Appl. No.: 17/759,902

(22) PCT Filed: Feb. 5, 2021
(86) PCT No.: PCT/EP2021/052887

§ 371 Date: Aug. 1, 2022

(30) Foreign Application Priority Data
Feb. 7, 2020 (DE) 10 2020 201 536.8

(51) Int. Cl. G01B 11/25

(52) U.S. Cl. CPC G01B 11/25

(57) ABSTRACT

The invention relates to an apparatus (1) and a method for contactless measuring of an object surface (2). In the proposed method, a temporally variable temperature distribution on the object surface (2) is generated by serially imprinting a plurality of thermal patterns (9) on the object surface (2). Subsequently, a thermal image of the object surface (2) is recorded by at least one thermal imaging camera (16, 17) at each of a plurality of successive recording instants, so that a respective sequence of thermal image values is acquired for points in an image plane (18, 19) of the thermal imaging camera or each of the thermal imaging cameras (16, 17). Corresponding points (20, 21) are then identified in the image planes (18, 19) of the thermal imaging cameras (16, 17) or in the image plane of the thermal imaging camera and in an image plane associated with the radiation source (6) by maximizing a similarity between the sequences of thermal image values detected or simulated for potentially corresponding points. Then spatial coordinates of the object surface (2) are determined by triangulation based on the points (20, 21) identified as being corresponding. When imprinting the patterns (9), surface elements are spatially limited such that an image of each area irradiated by a single one of the irradiation pulses in the image plane (18, 19) of the thermal imaging camera or each of the thermal imaging cameras (16, 17) is smaller than 5% of a total area of said image plane (18, 19).

The invention relates to a method for contactless geometric measurement of an object surface by irradiation with a radiation source, the radiation source being configured in such a way that a temperature increase takes place on the object surface as a result of the radiation when it impinges on the object surface, and to the recording and processing of thermal images recorded with at least one thermal imaging camera. The invention also relates to an apparatus for contactless geometric measurement of an object surface, with which this method can be carried out.

Many different methods for contactless measuring of object surfaces are known. Such methods typically use a projector to project patterns onto a surface to be measured and at least one camera to record the surface with the patterns projected onto it. For example, DE 10 2006 049 695 A1 describes a method in which fringe patterns are projected onto an object and two images of the object with the projected fringe patterns are taken from two different directions by means of two camera lenses arranged at a defined distance from each other, so that phase values can be determined for image points in the images of the object. Based on this, corresponding pixels are then identified in the images captured with the two camera lenses. Based on the corresponding image points, depth information for object points mapped onto these image points is then determined by triangulation.

This and similar prior art methods can be used to satisfactorily measure surfaces of a variety of materials. For highly reflective, transparent, translucent or strongly absorbing object surfaces, however, such known methods do not provide useful or only very inaccurate results. These methods are therefore not suitable for objects made of a variety of technologically relevant materials, such as glass, metal or fiber composites, and also for objects with smooth painted surfaces.

From thermography, the shape measurement of objects by heating them over a large area by means of a thermal source (6 tubes, 1200 W per tube) and subsequent evaluation of the temperature profile in the images of a thermal imaging camera is known.

Shape measurement using structured thermal heating and thermal imaging has also already been demonstrated on glass, where a CO₂ laser was used to actively project fringe patterns, thereby generating thermal zones, which were in turn detected using a thermal imaging camera. Based on the triangulation principle, the 3D geometric data of the vitreous bodies could be calculated and displayed. A similar measurement principle using a structured emission surface with or without an additional pattern element to generate defined areal patterns is known from publication DE 10 2008 064 104 B4. The projected patterns create an areal heat distribution on the objects, which is radiated from the object surface and detected by a thermal imaging camera.

In contrast to the defined thermal pattern sequences, according to DE 10 2015 211 954 B4 irregular statistically varying areal patterns (e.g. speckle-like patterns or aperiodic sinusoidal patterns as in DE 10 2013 013 791 B4) are not only imaged onto the measured object but are thermally imprinted as a result of local heating. These thermal patterns change in time due to the diffusion of heat in the material.

DE 10 2015 211 954 A1 describes a thermographic method for contactless measuring of an object surface, in which at least one two-dimensional thermal pattern is imprinted on the object surface and sequences of thermal images are recorded by two thermal imaging cameras for which homologous points can be assigned to one another in each case, the object surface being determined by triangulation on the basis of the points of the two thermal imaging cameras recognized as corresponding in each case.

The object of the present invention is to propose a method which also allows transparent, translucent or strongly reflecting or absorbing object surfaces, even of objects with considerable thermal conductivity, to be measured without contact and more quickly and accurately than in the prior art. In addition, the invention has the object of proposing a corresponding apparatus with which such surfaces can also be measured without contact.

This object is solved according to the invention by a method with the features of the main claim as well as by an apparatus with the features of the secondary independent claim. Advantageous further embodiments result with the features of the dependent claims and the embodiments.

Accordingly, the invention relates to a method for contactless measuring of an object surface comprising the following steps:
generating a temporally variable temperature distribution on the object surface by imprinting a plurality of chronologically sequential different thermal patterns on the object surface by irradiation with a radiation source with chronologically sequential irradiation pulses, by which in each case one or more surface elements are irradiated on the object surface, the radiation source being such that radiation produced by it causes a temperature increase on the object surface when it impinges thereon,
recording of the object surface by one or more thermal imaging cameras at a plurality of successive recording instants, wherein, in the case of detection by a plurality of thermal imaging cameras, this takes place simultaneously, so that a respective sequence of thermal image values is detected for points in a respective image plane of the one or more thermal imaging cameras,
identifying mutually corresponding points either in the image planes of the thermal imaging cameras or in an image plane of the thermal imaging camera and in a real or virtual image plane associated with the radiation source by determining for pairs of potentially corresponding points, on the basis of a mathematical measure of similarity, a similarity between the sequences of thermal image values detected for the points of the respective pair or, in the case of points in the real or virtual image plane associated with the radiation source, determined by simulation, and maximizing the similarity by varying at least one of the points of the respective pair, and
determining spatial coordinates of the object surface by triangulation based on the points identified as being corresponding,

wherein the irradiated surface elements are spatially limited such that an image of each area irradiated by a single one of the irradiation pulses in the image plane of the thermal imaging camera or each of the thermal imaging cameras is smaller than 5% of a total area of said image plane, preferably even smaller than 2.5% of the total area of the image plane. The term “image plane” refers only to the area of the corresponding plane in which the respective thermal imaging camera is able to capture an image, typically a surface of an image sensor of the thermal imaging camera. The image plane in the sense of the present document is thus delimited by an outer boundary of a region of the plane defining the image plane that is detectable by the respective thermal imaging camera. The mentioned narrow spatial limitation of the irradiated area refers only to the surface element(s) actually irradiated with the respective single irradiation pulse, but not necessarily to the resulting thermal patterns, whose areal sizes will increase over time due to thermal diffusion and may also exceed the upper limit defined above for the respective irradiated area.

The surface elements irradiated with the individual irradiation pulses may be, for example, dot-shaped or line-shaped and each so small or narrow that, in the case of a dot-shaped surface element, a diameter and, in the case of a line-shaped surface element, a line width of an image of the respective dot-shaped or line-shaped surface element in the image plane of the thermal imager or each of the thermal imaging cameras is smaller than 1/50 of a largest diameter of that image plane.

The largest diameter of the image plane will typically be the length of an image diagonal, e.g. a diagonal of the image sensor of the thermal imaging camera concerned. According to the invention, the surface elements irradiated in each case are thus spatially narrowly limited and thus relatively small in area.

It is particularly advantageous if the surface elements irradiated in the various irradiation pulses—at least in the case of some of the consecutive irradiation pulses—are not only different but also spaced apart. The fact that surface elements irradiated in successive irradiation pulses are spaced apart from each other should mean that, at least in the case of some of the irradiation pulses, the surface elements irradiated in consecutive irradiation pulses do not touch each other. It can be advantageous if a distance remains between the surface elements illuminated consecutively which is so large that an image of this distance in the image plane of the thermal imaging camera or each of the thermal imaging cameras is larger than 1/100 or 2/100 or even 5/100 of the largest diameter of this image plane and/or in the case of point-shaped or line-shaped irradiated surface elements larger than the diameter or the line width of the images of the respective irradiated point-shaped or line-shaped surface elements in the image plane. The diameter (in the case of a point-shaped surface element) or the line width (in the case of a line-shaped surface element) of the image of the respective point-shaped or line-shaped surface element in the image plane of the thermal imaging camera or each of the thermal imaging cameras will be even smaller than 1/100 or smaller than 1/200 of the largest diameter of this image plane in typical embodiments of the method.

By the method according to the invention, different thermal patterns are sequentially imprinted on the object surface by irradiation with a radiation source. The irradiated surface elements can, for example, be point-shaped or line-shaped. In any case, the extent of the irradiated surface elements is narrowly limited, so that with an available radiation source, for example an opto-electronic component such as an LED or a laser, the essential available power can be concentrated on a very small portion of the entire object surface that can be irradiated and measured. Thus, with a limited available power, a considerable temperature increase can nevertheless be achieved in small areas of the object surface in a very short irradiation time. The radiation source can be an infrared light source, but this is not absolutely necessary because heat can also be introduced into the object surface to be measured with radiation of other wavelengths.

Due to the only short irradiation time required, a large number of different surface elements can be irradiated one after the other in a short time if necessary. Likewise, a high number of thermal images can be captured in a short time. Due to the comparatively short time required for imprinting the individual thermal patterns, as well as due to the narrow spatial limitation of these patterns or of the individual surface elements of these patterns, high contrast can be achieved in the thermal patterns and consequently also in the recorded thermal images, despite unavoidable heat diffusion, which is helpful for accurate and rapid identification of corresponding points or homologous points (both terms are used synonymously here) and therefore makes the proposed method for measuring surfaces faster and more accurate compared to the prior art.

This new structuring when imprinting temperature distributions on the object surface achieves significant advantages over the prior art.

In the prior art, the irradiation intensity is not sufficiently high due to the areal irradiation of the object surface, so that per pattern, the measuring object must be irradiated over a relatively long period of time in the range of seconds. After this period, the maximum temperature or radiance contrast is lower than when working with higher irradiance and correspondingly shorter irradiation duration. Thermal diffusion counteracts the building thermal contrast with increasing time. This limits the signal-to-noise ratio and measurement accuracy for measurements according to the state of the art.

This long period of irradiation of the object surface also increases the total heat input into the volume of the target due to thermal diffusion. The temperature of the measured object may increase by several Kelvin.

In pattern generation using absorption masks, one has high radiation losses during irradiation.

The measurement of objects with high thermal conductivity (e.g. metals) is hardly possible due to a low maximum temperature or radiation density contrast according to the prior art.

The disadvantages mentioned, which arise when generating temperature distributions with irradiation distributed over too large a surface area, are all avoided by limiting the size of the irradiated surface elements according to the invention. Measurements can therefore be performed faster and with greater contrast than before.

The radiation source can be an LED or a laser, for example an infrared laser, and a scanning beam or a projection of the radiation source by means of a projector can be provided. In this way, unlike the use of masks, for example, a significant part of the power of the radiation source can be concentrated on a small part of the object surface.

The diameter of an irradiated surface element, for example point-shaped, or the width of an irradiated surface element, for example line-shaped, is so small due to the mentioned narrow spatial limitation of these surface elements that the corresponding surface area can be heated sufficiently quickly and strongly, so that temperature compensation by thermal diffusion during irradiation is negligible. As a result, a high contrast and thus a high signal-to-noise ratio can be achieved when thermal structures are determined by the thermal imaging cameras. Overall, both the imprinting of a series of thermal patterns and the measurement of the necessary thermal images can be completed in a short time. The mentioned area limitation of the area irradiated by the individual irradiation pulses or, in the mentioned special case of point-shaped or line-shaped irradiated surface elements, the size limitation of the diameter of a point-shaped or the width of a line-shaped irradiated surface element can also be formulated in such a way that the solid angle or angle at which the irradiated area or the diameter of the point-shaped or the width of a line-shaped surface element appears as seen from the radiation source is smaller than 5% of a largest solid angle or 1/50 of the largest angle at which the surface detectable with the thermal imaging camera or each of the thermal imaging cameras appears as seen from the thermal imaging camera.

The similarity measure used to determine the similarity of sequences may or may not have all the properties of a metric in the strict sense of the word. The only important thing here is that the similarity measure is suitable for providing a measure of similarity between sequences of values that is suitable for finding sequences that are as similar as possible. In the case of using a metric in the sense of the mathematical definition of the term, the mentioned maximizing of similarity would naturally result from minimizing a distance defined by the metric.

More conveniently, the similarity between sequences of thermal image values can be determined by evaluating a correlation function defined for pairs of sequences of values, where the corresponding points can then be identified respectively by maximizing or minimizing a value of a correlation thus formed. The correlation function can be chosen arbitrarily within wide limits and only has to show the typical property for correlation functions to assume an extremum—typically a maximum—in case of identity of the sequences compared by evaluation of the correlation function and to come closer to this extremum the more similar the compared sequences are.

Typically, the described method will be performed by means of at least two thermal imaging cameras:
simultaneously obtaining a thermal image of the object surface by each of the at least two spaced-apart thermal imaging cameras at a plurality of successive recording instants, so that a sequence of thermal image values is acquired for points in an image plane of each of the thermal imaging cameras,
identifying corresponding points in the image planes of the thermal imaging cameras by determining, for pairs of potentially corresponding points, a similarity between the sequences of thermal image values obtained for the points of the respective pair using a mathematical measure of similarity and maximizing the similarity by varying at least one of the points of the respective pair,
determining spatial coordinates of the object surface by triangulation based on the points identified as being corresponding.

In this case, the thermal patterns imprinted on the object surface need not be known. Rather, the patterns may be chosen entirely at random and may be, in particular, statistical or quasi-statistical in nature, provided only that they are sufficiently contrasting, structurally rich, and different. Consequently, the same applies—within the framework of the previously mentioned conditions—to the exact geometric properties of the irradiation pulses used to generate the thermal patterns, for example the exact positions and/or orientations of the irradiated surface elements. Therefore, advantageously, the internal geometry of an apparatus used to carry out the method does not have to be completely known when at least two thermal imaging cameras are used. For example, in the case of using a projection device to generate the thermal patterns, their exact placement relative to the thermal imaging cameras is not important. This makes the method comparatively insensitive to tolerances in the design of the fixture used. In all this, triangulation is based on an extremely uncomplicated evaluation of the thermal images.

However, in some circumstances it may be sufficient to use only one thermal imaging camera. When using only a single thermal imaging camera, the radiation source or a device for imprinting the thermal patterns with the radiation source is treated like a second, virtual camera as it were, with regard to the steps of identifying homologous points and determining spatial coordinates of the object surface by triangulation, which can thus be assigned to the radiation source or the device for imprinting the thermal patterns. Also points in a virtual or (in case of a radiation source matrix) real image plane of this virtual camera, as it were (i.e. points in a real or virtual image plane assigned to the radiation source or the device for imprinting the thermal patterns) can be assigned (simulated) thermal image values. In fact, these thermal image values result from the integrated radiant power that was emitted in each case in a beam direction corresponding to the respective point (in the real or virtual image plane). However, unless heat diffusion is negligible in the time periods involved, it may be necessary to account for heat diffusion by simulation in order to determine useful (time-evolving) thermal image values in the image plane associated with the radiation source. However, this can be easily achieved in particular if the material forming the object surface and/or an approximate shape of the object surface is already known. It is therefore possible that in this case a partially or approximately known surface shape of the object surface to be measured must be assumed and on this basis the development of corresponding heat values on the object surface must be approximately determined by means of a simulation calculation. If a surface shape is then determined by triangulation with the thermal image values from the camera, this shape can be used iteratively for the simulation calculation so that the process converges to a final determined shape of the object surface.

By using thermal imaging cameras, the method is also suitable for measuring object surfaces that are transparent or translucent in the visible range of the electromagnetic spectrum or that are highly reflective or absorbent, unlike comparable methods in which light patterns are projected and recorded. With surfaces of this type, a projected light pattern would either not be visible at all in an image of an ordinary camera, because projected light would be transmitted too strongly, absorbed or reflected in a direction unfavorable for the camera, or backscattered light components would fall into the camera, which would come from deeper layers behind the object surface. Both would render a reliable identification of corresponding points and therefore also the correct determination of the necessary depth information by triangulation impossible. This problem is solved in the proposed method by using temperature distributions instead of light patterns. On the one hand, these can be generated more easily even with transparent or translucent materials limited to a surface area, while light patterns in these cases inevitably penetrate deep into the material. On the other hand, imaging with thermal imaging cameras allows the reliable generation of images of the object surface characterized by the respective thermal pattern even if one would not see enough with a camera operating in the visible range either due to unfavorable reflection or strong absorption or if one would look too deep into the material.

It can also be provided that in successive immediately following irradiation pulses, abruptly changing and spaced surface elements are irradiated, in particular in the form of a single line in each case. A not too small distance between the surface elements irradiated with successive thermal patterns has the advantage that a contrast subsequently recorded thermal images is not unnecessarily strongly disturbed by diffusion of previously projected patterns.

This allows sufficiently different thermal structures to be imprinted on the object surface in short time intervals, which, given sufficient intensity of irradiation/heat generation, significantly reduces the total measurement time required for sufficiently unambiguous determination of sufficiently many pairs of homologous points.

It can be provided that the radiation source first generates a beam, for example a laser beam, whereby this beam is expanded by an optical expansion element, for example consisting of one or more cylindrical lenses, in such a way that it irradiates a surface element on the object surface in the form of a line.

Such an optical expansion element can thus be used, for example, to generate a line-shaped beam by means of a laser beam focused on a point.

It may further be provided that at least one of the thermal image recording instants is in a time interval during which no new thermal pattern is imprinted on the object surface, so that the temperature distribution on the object surface changes between the previous recording instant and this at least one recording instant essentially only by thermal diffusion.

Alternatively or additionally, it can also be provided that at least one of the recording instants of thermal images is at a time after the imprinting of a further thermal pattern on the object surface, so that the temperature distribution on the object surface changes between the preceding recording instant and this at least one recording instant, on the one hand, by thermal diffusion and, moreover, by a further energy input by a further irradiation pulse.

In any case, it is advantageous if at least one of the recording instants—typically this applies to several of the recording instants and possibly also to all recording instants—immediately follows one of the irradiation pulses in each case or an irradiation process formed by several of said irradiation pulses, because in this way (in particular because of the required spatial limitation of the surface elements irradiated in each case) very high-contrast thermal images can be generated which are well suited for precise determination of homologous points. The wording “immediately following an irradiation pulse or irradiation process” refers in particular to times whose temporal interval from the irradiation pulse or from the last irradiation pulse of the respective irradiation process is shorter than the duration of this irradiation pulse or than the average duration of the individual irradiation pulses of the irradiation process.

It may be provided that the similarity between sequences of thermal image values or between sequences of thermal image values is determined by evaluating a correlation function defined for pairs of sequences of values, and the corresponding points are respectively identified by maximizing or minimizing a value of a correlation thus formed.

The proposed apparatus for contactless measuring of surfaces is analogously as advantageous as the described method. This apparatus comprises a device for imprinting thermal patterns on an object surface to be arranged in an object space for measurement, having a radiation source, the radiation source being such that radiation generated by it causes an increase in temperature on the object surface when it impinges thereon, one or more thermal imaging cameras, spaced apart from one another, for recording thermal images of the object surface in the object space, and a control and evaluation unit for controlling the device for imprinting thermal patterns and the one or more thermal imaging cameras and for evaluating the thermal images recorded thereby, the control and evaluation unit being configured, in cooperation with the device for imprinting thermal patterns, to perform the following steps:
generating a temporally variable temperature distribution on the object surface by imprinting a plurality of chronologically sequential different thermal patterns on the object surface by irradiation with the radiation source with chronologically sequential irradiation pulses each suitable for irradiating one or more surface elements on the object surface, wherein the irradiated surface elements are spatially limited such that an image of each area irradiated by a single one of the irradiation pulses in an image plane of the thermal imaging camera or each of the thermal imaging cameras is smaller than 5% or than 2.5% of a total area of said image plane,
recording of the object surface by the one or more thermal imaging cameras at a plurality of successive recording instants, wherein, in the case of detection by a plurality of thermal imaging cameras, this takes place simultaneously, so that a respective sequence of thermal image values is detected for points in the respective image plane of the one or more thermal imaging cameras,
identifying mutually corresponding points either in the image planes of the thermal imaging cameras or in an image plane of the thermal imaging camera and in a real or virtual image plane of the device for imprinting thermal patterns by determining for pairs of potentially corresponding points, on the basis of a mathematical measure of similarity, a similarity between the sequences of thermal image values detected for the points of the respective pair or, in the case of points in the real or virtual image plane associated with the radiation source, determined by simulation, and maximizing the similarity by varying at least one of the points of the respective pair, and
determining spatial coordinates of the object surface by triangulation based on the points identified as being corresponding.

The device for imprinting thermal patterns and the control and evaluation unit can be configured in such a way that the surface elements irradiated in the various irradiation pulses are different and spaced apart from one another at least in the case of some of the consecutive irradiation pulses and/or that the surface elements irradiated with the individual irradiation pulses are point-shaped or line-shaped and are in each case so small or narrow that, in the case of a point-shaped surface element, a diameter and, in the case of a line-shaped surface element, a line width of an image of the respective point-shaped or line-shaped surface element in the image plane of the thermal imaging camera or of each of the thermal imaging cameras is smaller than 1/50—in some embodiments also smaller than 1/100 or even smaller than 1/200—of a largest diameter of this image plane.

Such an apparatus can be used to carry out the method described and can also be configured in such a way that it is suitable for carrying out the optional embodiments of the method described here or that its control and evaluation unit is configured to carry out the steps mentioned—interacting with the device for imprinting the thermal patterns—in accordance with these embodiments.

For a reduction of the search effort in the identification of the corresponding points, a restriction of the points that can be considered to potentially be corresponding can be made by exploiting the epipolar geometry. Thus, the variation of the at least one of the points can be limited to a restricted area of the respective image plane, because only the points lying on epipolar lines defined by the respective other point and the inner geometry of the system of the two thermal imaging cameras can be considered as corresponding points. For example, identifying the corresponding points may be accomplished by searching for the corresponding point for each of a plurality of points in the image plane of a first of the thermal imaging cameras on a corresponding epipolar line in the image plane of a second of the thermal imagers by evaluating the correlation function or similarity measure used between the sequence of thermal image values acquired for the respective point in the image plane of the first thermal imager and the sequences of thermal image values acquired for the points on the corresponding epipolar line in the image plane of the second thermal imager. The corresponding point can then be found as the point in the image plane of the second camera for which the correlation or similarity formed in this way assumes the greatest value, i.e. for which, for example, the correlation function assumes a maximum and consequently the value of the correlation is maximized. The corresponding point can be determined with subpixel accuracy, including subpixel interpolation.

It may be provided that at least one of the recording instants lies in a time interval during which no new thermal pattern is imprinted on the object surface, so that the temperature distribution on the object surface changes by thermal diffusion between the previous recording instant and this at least one recording instant. The temperature distribution on the object surface at this at least one recording instant can therefore differ in particular from the thermal pattern last imprinted on the object surface. The fact that the temperature distribution on the object surface changes automatically can thus be exploited in an advantageous way to capture comparatively easily and quickly a sufficiently large number of sufficiently different thermal image pairs, which can then be used to identify homologous points and for triangulation.

Once a thermal pattern is imprinted on an object surface, the temperature distribution undergoes a temporal evolution due to thermal diffusion. As a rule, temperature differences between warmer and colder areas of the surfaces decrease over time. In contrast to the use of conventional light patterns, recording and imprinting do not necessarily have to be synchronized in time. In particular, for example, a sufficiently strong temporal change of the thermal image values can be achieved by a single imprinting followed by subsequent obtaining of thermal images at least twice. Typically, imprinting is followed by multiple recordings. It is also conceivable that first a simultaneous imprinting and recording takes place and then thermal images are captured several times without a new imprinting. Even though it is not impossible that a new thermal pattern is imprinted before each recording or that the recording and the imprinting are basically synchronous, even if several thermal patterns are imprinted, several thermal image pairs can be acquired after and possibly also during the imprinting of each of these thermal patterns before the next thermal pattern is imprinted.

With regard to the explained possibility of exploiting thermal diffusion, it can be useful if the control and evaluation unit is configured to control the thermal pattern imprinting device and the thermal imaging cameras in such a way that at least one of the recording instants lies in a time interval during which the thermal pattern imprinting device does not imprint a new thermal pattern. The most recent imprinting of a thermal pattern, on the other hand, may have already ended at this at least one recording instant.

The at least one thermal pattern can be imprinted, for example, by a projection device. Thus, said thermal pattern imprinting device may be, in particular, a projection device. The radiation source may be an opto-electronic component and or an infrared light source. Typically, the radiation source will be an LED or a laser. The choice of the radiation source may depend on the material of an object to be measured. It is expedient to use a radiation source that allows efficient heating of the material. The radiation source can be configured for pulsed or continuous emission of radiation power.

In the case of using a projection device, it may be convenient if this imprints the at least one optical pattern on the object surface by infrared radiation. Thus, expediently, the projection device has a radiation source for generating infrared radiation. For example, the projection device may include a carbon dioxide laser that emits infrared radiation with a wavelength of about 10.6 Linn. Such a radiation source is advantageous for measuring surfaces made of glass, since many types of glass have a high absorption coefficient in this wavelength range, so that they can be heated particularly efficiently when irradiated by a carbon dioxide laser.

Since the measurement, unlike conventional pattern projection methods, is not based on a detection of reflection or scattering of electromagnetic radiation, but on an emission of electromagnetic radiation by the object to be measured and on a detection of the radiation thus emitted, a spectral range of the thermal imaging cameras used can be selected or varied according to the emission wavelengths. For example, the spectral range of the thermal imaging cameras used can be in the far infrared radiation range between 5 μm and 14 μm or in the mid infrared radiation range between 3 μm and 5 μm. Depending on the temperatures covered by the time-dependent temperature distribution, it may also be possible to detect electromagnetic radiation in the near infrared range or at wavelengths above 14 μm. For measuring, for example, a surface of an object made of glass, detection at wavelengths of more than 5 μm is advantageous, since many types of glass do not exhibit transparency in this wavelength range. Therefore, in this way it can be achieved that the radiation detected with the thermal imaging cameras comes from the surface of the object to be measured and not from the volume of the object. Sensitivities in the wavelength range first mentioned, in turn, can also be advantageous in particular because particularly significant changes in intensity of the thermal radiation occur in this wavelength range when heated by the thermal patterns, starting from usual room temperatures. It is possible, but not necessary, for the sensitivity range of the thermal imaging cameras to coincide or even overlap with the spectrum of a projection device used to generate the thermal patterns.

The thermal pattern imprinting device may include an optical expansion element, for example in the form of a cylindrical lens or system of lenses or a mirror, which expands a beam from the radiation source directed at a point on the object surface to form a line.

A further embodiment is possible by means of a controllable optical deflection device for the radiation emitted by the radiation source for the abrupt displacement of the—for example point-shaped and/or line-shaped—surface elements irradiated by the radiation source.

It can be advantageous if the distance between the surface elements illuminated consecutively created by the displacement is so large that an image of this distance in the image plane of the thermal imaging camera or each of the thermal imaging cameras is larger than 1/100 or 2/100 or even 5/100 of the largest diameter of this image plane and/or—in the case of point-shaped or line-shaped irradiated surface elements—larger than the diameter or the line width of the images of the respective irradiated point-shaped or line-shaped surface elements in the image plane.

It can also be provided that the control and evaluation unit is configured to control the device for imprinting thermal patterns and the thermal imaging cameras in such a way that at least one of the recording instants lies in a time interval during which the device for imprinting thermal patterns does not imprint a new thermal pattern, and/or that the control and evaluation unit is configured to control the device for imprinting thermal patterns and the thermal imaging cameras in such a way that at least one of the recording instants lies at a time after the imprinting of a further thermal pattern on the object surface, so that the temperature distribution on the object surface changes between the previous recording instant and this at least one recording instant on the one hand by thermal diffusion and also by a further energy input by a further irradiation pulse.

The apparatus can be further configured in that the control and evaluation unit is configured to determine the similarity between sequences of thermal image values by evaluating a correlation function defined for pairs of value sequences and to identify the corresponding points respectively by maximizing or minimizing a value of a correlation thus formed.

Compared to known methods for contactless measuring of surfaces, the irradiated area per irradiation process—formed by one or more of the aforementioned irradiation pulses—can be significantly reduced and the irradiation intensity significantly increased with the method proposed here. Thus, an irradiation time until a temperature contrast sufficient for a 3D reconstruction (i.e. for the described determination of the spatial coordinates of the object surface) can be kept advantageously short. This reduces the negative influence of thermal diffusion on the contrast buildup. Consequently, the negative influence of thermal diffusion is also significantly reduced, and the same contrast values can be achieved with significantly shorter irradiation times or higher contrast values with comparable irradiation times. This makes it possible, in particular, to measure surfaces made of materials with higher thermal conductivities.

Embodiments of the invention are hereinafter described by way of the figures. Shown are

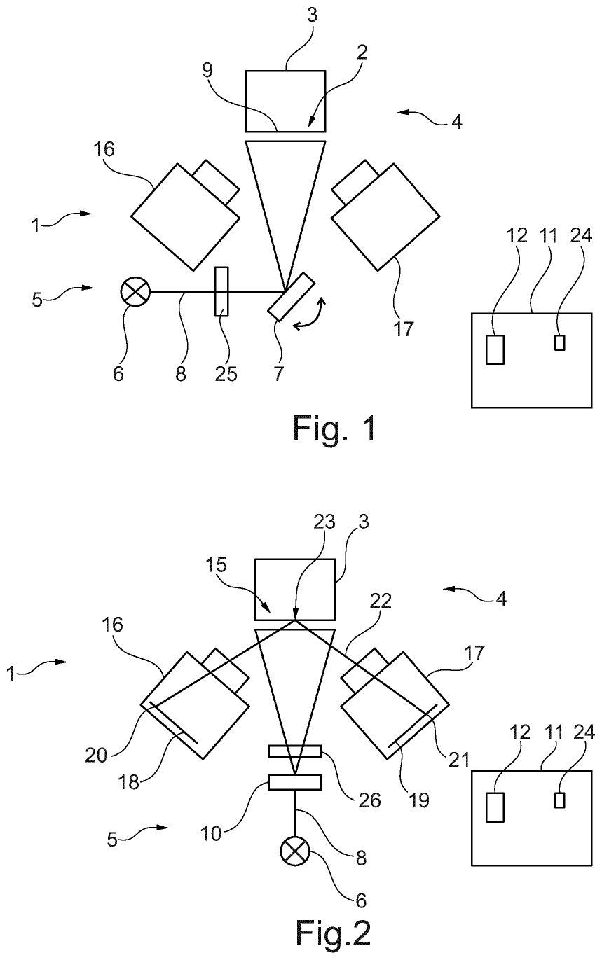

FIG. 1 a schematic view of an apparatus for contactless measuring of an object surface and an object measured therewith,

FIG. 2 a schematic top view of a further apparatus for contactless measuring of an object surface and an object measured with it, and

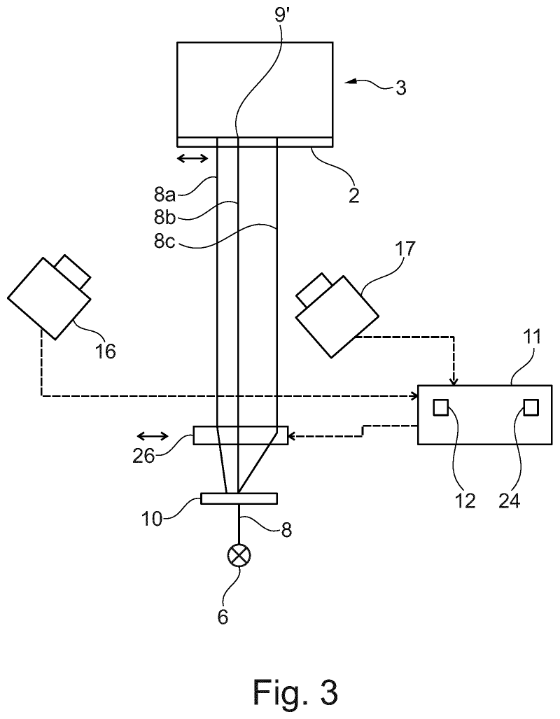

FIG. 3 is a schematic representation of a similar apparatus in which three separate, parallel lines are simultaneously imprinted on the object surface as a thermal pattern.

FIG. 1 shows an embodiment of an apparatus 1 for contactless measuring of an object surface 2 of an object 3 in an object space 4. The apparatus 1 comprises a projection device 5 as a device for imprinting linear thermal patterns 9 on the object surface 2 of the object 3. The projection device 5 comprises a radiation source 6, for example a carbon dioxide laser, and an optical element 7 in the form of a reflecting element which directs the radiation to the object surface 2 and can be controlled and driven in such a way that it abruptly changes its angular position in order to abruptly displace surface elements respectively irradiated by the radiation source 6 on the object surface and thereby achieve that the thermal patterns 9 produced by consecutive irradiation pulses differ very significantly from one another. The reflecting element can be in the form of a grille, a mirror, or a freeform element. The carbon dioxide laser emits infrared radiation 8 in the form of a focused beam, which is reflected or diffracted by the optical element 7 and subsequently strikes the object surface 2, heating it along a very narrow line, for example. A cylindrical lens 25 is arranged in the beam path of the beam 8, which expands the laser beam on the object surface 2 to form a pattern 9 in the form of a line—here oriented perpendicular to the drawing plane. Instead of the cylindrical lens 25, another optical expansion element may be provided, such as a lens system with multiple cylindrical lenses. Furthermore, the cylindrical lens 25 or the expansion element replacing it may be arranged behind the optical element 7 instead of in front of it. Instead of the carbon dioxide laser, another laser or an LED, for example, can also be used as the radiation source 6. Here, the radiation source 6 need not necessarily be an infrared light source, as long as it is only suitable for causing a local temperature increase on the object surface 2. Accordingly, other electromagnetic radiation, in particular light of a different wavelength, can also take the place of infrared radiation 8.

The object 3 to be measured is made of silicate glass, for example, but it can also be made of another material, and even materials that have better thermal conductivity are possible, and the surface of the object 3 is heated on a very small, line-shaped part of the object surface by the infrared radiation 8 reflected or diffracted at the optical element 7. The reflective element 7 is moved on abruptly at short intervals, and an irradiation pulse of high intensity is directed via the element to a different line-shaped area of the object surface in each case. For example, if the cylindrical lens is to be omitted, the reflective element may also be designed to direct a beam tightly focused on a point to a line on the object surface. However, the reflective element can also be designed in such a way that it merely reflects the radiation without distortion if, for example, a cylindrical lens is also provided.

Another embodiment of an apparatus 1 with a projection device 5 is shown schematically in FIG. 2. Recurring features are marked with the same reference signs in this and also in the following figures. In this embodiment, the projection device comprises a transmitting optical element 10, which may again be a grille or a free-form element or, specifically, a cylindrical lens, and which is disposed between the radiation source 6 and the object surface 2. Here, the radiation source 6 generates an infrared radiation 8 which impinges on the optical element 10, is transmitted through it, and is thereby formed, for example, into a beam which is expanded in a line-like manner in one dimension. After passing through the optical element 10, the infrared radiation 8 generated by the radiation source 6 impinges on a movable optical element 26, is directed by it to desired areas of the object surface 2, and heats it in the form of a thermal, line-shaped pattern 9. The movable optical element can be designed as a lens, for example also as a cylindrical lens, if the element 10 does not form the beam 8, but only focuses or collimates it. The optical element 26 can be driven by a motor and controlled by a computer 11 or a control and evaluation unit 12.

The apparatus 1 thus has—also in the previously described embodiment—among other things a computer 11 with a control and evaluation unit 12. The projection device 5 and also the drivable optical element 7 or the displaceable optical element 26 are controlled by the control and evaluation unit 12. This thus determines at which times which thermal patterns 9 are imprinted on the object surface 2. In addition, the control and evaluation unit 12 is configured to move the optical element 7 or 10 and/or 26 so that the linear thermal pattern 9 can be spatially shifted by the control and evaluation unit 12 as a function of time.

After the radiation source 6 is switched off, a temperature distribution imposed by the thermal pattern 9 evolves in time by a thermal conduction in the object 3.

As in the previously described embodiment, the apparatus 1 comprises a first thermal imaging camera 16 and a second thermal imaging camera 17, each of which may have filters to suppress volume radiation from the object 3. The thermal imaging cameras 16, 17 are sensitive to electromagnetic radiation in the IR range, for example to thermal radiation in a wavelength range between 7.5 μm and 14 μm. The thermal imaging cameras 16, 17 are arranged at a distance from each other and are also controlled by the control and evaluation unit 12. The first thermal imaging camera 16 and the second thermal imaging camera 17 are configured and aligned in such a way that they can capture the temperature distribution 15 at least in an area of the object surface 2 in their respective image planes 18, 19 simultaneously, i.e. by capturing one thermal image each at the same time. For this purpose, the intensity of a thermal radiation 22 measured in points 20, 21 in the respective image planes 18, 19 is evaluated.

In a simultaneous recording of the respective thermal images, a point 23 of the object surface 2 is imaged onto a first point 20 in the image plane 18 of the first thermal imaging camera 16 and onto a second point 21 in the image plane 19 of the second thermal imaging camera 17, as shown in FIG. 2. The first point 20 and the second point 21 form a pair of corresponding points.

After imprinting the thermal pattern 9, the control and evaluation unit 12 controls a shutdown of the radiation source 6 by closing a shutter or switching off the infrared light source (e.g. the laser) and triggers a simultaneous recording of thermal images by the thermal imaging cameras 16, 17. Subsequently, the temperature distribution on the object surface 2 develops by heat diffusion. The control and evaluation unit 12 triggers a repeated simultaneous recording of thermal images with the radiation source 6 switched off and also after renewed irradiation of the object surface with a line-shaped pattern that is shifted in relation to the first irradiation pulse. The described steps of imprinting a thermal pattern 9 and recording thermal images are repeated several times with different or in each case identical but mutually displaced thermal patterns 9. The time-dependent temperature distribution 15 generated by the various imprinted thermal patterns 9 can also be detected while imprinting the respective thermal pattern 9, i.e. without previously closing a shutter or switching off the infrared light source. In that case, it may be advantageous to ensure that only the radiation emitted by the object surface 2 is detected, but not the scattered or reflected radiation from the radiation source 6, by using filters that are opaque to radiation from the radiation source 6 or by using a sensitivity spectrum of the thermal imaging cameras 16, 17 that does not include the wavelength of this radiation—in the present example, 10.6 μm. Provided that a sufficiently large number of different thermal patterns 9 are imprinted, it may also be sufficient if only one pair of thermal images is recorded for each imprint, either during the imprint or shortly thereafter. It is also possible to record at least one thermal image pair during the imprinting of each of the thermal patterns 9 and to record thermal image pairs once or several times after closing the shutter and, if necessary, before imprinting the next thermal pattern 9. The respective thermal images are temporarily stored on a data storage 24 so that a sequence of thermal image values is stored thereon for each point in the image planes 18, 19 of the thermal imaging cameras 16, 17.

In a next step, the control and evaluation unit 12 compares the acquired sequence of thermal image values for each point 20 in the image plane 18 of the first thermal imaging camera 16 with the sequences of thermal image values of the points in the image plane 19 of the second thermal imaging camera 17 to identify the corresponding points 20, 21. The control and evaluation unit 12, when finding the point 21 in the image plane 19 of the second thermal imaging camera 17 corresponding to the point 20 in the image plane 18 of the first thermal imaging camera 16, is limited to points in the image plane 19 of the second thermal imaging camera 17 that lie on an epipolar line defined by the point 20 in the image plane 18 of the first thermal imaging camera 16.

The pairs of sequences of thermal image values are compared by having the control and evaluation unit 12 assign a similarity value to each of the pairs of sequences using a correlation function, where the similarity value assumes a large value for a pronounced similarity of the sequences and a low value for very different sequences. One by one, the control and evaluation unit 12 evaluates the correlation function of the sequences for potentially corresponding points in pairs, and maximizing the similarity value, the actual corresponding points 20, 21 can be found in the image planes 18, 19 of the two thermal imaging cameras 16, 17. In another definition of the correlation function, it is also conceivable that the corresponding points 20, 21 are found by minimizing rather than maximizing a similarity value.

Subsequently, the control and evaluation unit 12 determines spatial coordinates of points 23 on the object surface 2 based on the previously found corresponding points 20, 21 in the image planes 18, 19 of the two thermal imaging cameras 16, 17. The fact that the relative position of the thermal imaging cameras 16, 17 is known is exploited to this end, the spatial coordinates being determined based on this by triangulation.

FIG. 3 shows a similar and correspondingly used apparatus 1 in which a beam 8 from a radiation source 6 is split into three mutually parallel beams 8a, 8b and 8c in an optical element 10. These pass through a shaping and displacement element 26, which has, for example, cylindrical lenses, each of which shapes linear beams that fall on the object surface 2 of the object 3. There, the beams form thermal patterns 9′ of 3 parallel lines each, which are recorded by the thermal imaging cameras 16, 17. At short time intervals, the displacement element 26 is abruptly displaced perpendicular to the direction of the beam 8a, 8b, 8c, so that the thermal pattern 9′ formed by the lines is also abruptly displaced in each case. The areas where the three lines are moved on the object surface in this way can be disjoint. The entire surface of the object can thus be accessed by a sequence of thermal structures 9′ shifted against each other. The control and evaluation unit 11, 12, 24 controls on the one hand the irradiation pulses of the radiation source 6, further the displacement of the element 26 and the thermal imaging cameras 16, 17 and also performs the further process steps up to triangulation.

The line-shaped irradiated surface elements in the described examples are spatially limited in such a way that an image of each surface irradiated by a single one of the irradiation pulses in the image plane 18, 19 of the thermal imaging camera or each of the thermal imaging cameras 16, 17 is smaller than 2.5% of a total area of this image plane 18, 19, i.e. smaller than 1/40 of the total area of the image plane, this image plane 18 or 19 being given by the sensitive surface of a thermal imaging sensor of the respective thermal imaging camera 16 or 17 and being to be understood as limited by its edge. In variations of the described embodiments, instead of the line-shaped thermal patterns or in addition thereto, point-shaped thermal patterns or also any other patterns can be imprinted on the object surface 2, provided that the irradiation pulses used for this purpose meet this condition or are at least not more than twice as large in terms of area or solid angle. It is also possible to omit one of the two thermal imaging cameras 16, 17 and instead to treat the projection device 5 as a virtual camera, as already explained above in a more general context, and to assign it an image plane—real or virtual—and to assign thermal image values to points in this image plane by simulation depending on the imposed thermal patterns, in order to then form pairs of one of these thermal image values and one of those actually detected by the remaining thermal imaging camera 16 or 17 and to determine in an otherwise analogous manner—by identifying pairs of corresponding points and by triangulating on the basis of these—the spatial coordinates of the points 23 on the object surface 2.

In the embodiments described herein, for imprinting the thermal patterns, the radiation source 6 respectively irradiates single or spaced-apart dot-shaped or line-shaped surface elements, each of which is so small or narrow that, in the case of a dot-shaped surface element, a diameter and, in the case of a line-shaped surface element, a line width of an image of the respective dot-shaped or line-shaped surface element in the image plane 18 or 19 of the thermal imaging cameras or each of the thermal imagers 16, 17 is smaller than 1/100 or even 1/200 of a largest diameter of this image plane 18 or 19. In this case, a distance remains between the surface elements illuminated consecutively for immediately successively imprinted thermal patterns, which is so large that an image of this distance in the image plane 18 or 19 of the thermal imaging camera or each of the thermal imaging cameras 16, 17 is larger than 2/100 or even 5/100 of the largest diameter of this image plane 18, 19. An image of this distance in the image plane 18 or 19 of the thermal imaging camera or each of the thermal imaging cameras 16, 17 is in particular larger than the diameter or the line width of the images of the respective irradiated point or line-shaped surface elements in the image plane 18 or 19. In the described embodiment examples, the largest diameter of the image plane 18 and 19 is given in each case by a diagonal of the thermal image sensor of the respective thermal imaging camera 16 or 17. The respective control and evaluation unit 12 of the apparatuses shown schematically in FIGS. 1 to 3 can be configured in particular in such a way that, interacting with the projection device 5, it executes the steps of the method described in the general description section in accordance with the various embodiments mentioned therein.

1. A method for contactless measuring of an object surface, the method comprising:
generating a temporally variable temperature distribution on the object surface by imprinting a plurality of chronologically sequential different thermal patterns on the object surface by irradiation with a radiation source using chronologically sequential irradiation pulses, wherein with each pulse one or more surface elements are irradiated on the object surface, wherein radiation produced the radiation source causes a temperature increase on the object surface when it impinges thereon;
detecting of the object surface by one or more thermal imaging cameras at a plurality of successive recording instants;
identifying mutually corresponding points in at least one of an image plane of the one or more thermal imaging cameras or in at least one of a real image plane or a virtual image plane associated with the radiation source, wherein the mutually corresponding points are identified by determining for one or more respective pairs of potentially corresponding points, a similarity between one or more sequences of thermal image values detected for the mutually corresponding points of the one or more respective pairs or, for points in the real image plane or the virtual image plane associated with the radiation source, determined by simulation, and maximizing the similarity by varying at least one of the points of the respective pair; and
determining one or more spatial coordinates of the object surface by triangulation based on the identified mutually corresponding points;
wherein the irradiated surface elements are spatially limited such that an image of each area irradiated by a single pulse of the chronologically sequential irradiation pulses in the image plane of the one or more thermal imaging cameras is smaller than 5% of a total area of the image plane.

2. The method according to claim 1, wherein the surface elements irradiated in each pulse of the chronologically sequential irradiation pulses are different and spaced apart from each other such that the one or more surface elements irradiated with individual irradiation pulses are dot-shaped or line-shaped.

3. The method according to claim 1, wherein alternating and spaced-apart surface elements are each irradiated in consecutive irradiation pulses.

4. The method according to claim 1, wherein a distance remains between consecutively illuminated surface elements, wherein an image of distance in the image plane of the one or more thermal imaging cameras or is larger than 1/100 of a largest diameter of the image plane.

5. The method according to claim 1, further comprising:
simultaneous obtaining a thermal image of the object surface from at least two spaced-apart thermal imaging cameras at a plurality of successive recording instants, so that a respective sequence of thermal image values is detected for points in an image plane of each of the at least two spaced-apart thermal imaging cameras;
identifying corresponding points in the image planes of the at least two thermal imaging camera by determining, for respective pairs of potentially corresponding points, a similarity between the respective sequences of thermal image values detected for the points of the respective pairs using a mathematical similarity measure;
maximizing the similarity by varying at least one of the points of the respective pairs; and
determining one or more spatial coordinates of the object surface by a triangulation based on the identified corresponding.

6. The method according to claim 1, wherein the radiation source is at least one of an infrared light source, an opto-electronic component, or a laser.

7. The method according to claim 1, wherein a particular recording instant lies in a time interval during which no new thermal pattern is imprinted on the object surface, and wherein the variable temperature distribution on the object surface changes by thermal diffusion between a preceding recording instant and the particular recording instant.

8. The method according to claim 7, wherein the particular recording instant is at an instant after the imprinting of a further thermal pattern on the object surface, so that the variable temperature distribution on the object surface further changes between the preceding recording instant and the particular by an energy input by a further irradiation pulse.

9. The method according to claim 1, wherein the similarity between the one or more sequences of thermal image values is determined by evaluating a correlation function defined for pairs of sequences of values, and wherein the mutually corresponding points are each identified by maximizing or minimizing a value of a correlation thus formed.

10. An apparatus for contactless measuring of surfaces, comprising:
a device for imprinting thermal patterns on an object surface to be arranged in an object space for measurement, using a radiation source, wherein radiation generated by the radiation source causes a temperature increase on the object surface when it impinges thereon;
one or more thermal imaging cameras spaced apart from each other for taking one or more thermal images of the object surface in the object space; and
a control and evaluation unit for controlling the device for imprinting thermal patterns and the one or more thermal imaging cameras and for evaluating the thermal images recorded thereby, wherein the control and evaluation unit in cooperation with the device for imprinting thermal patterns is configured to:
generate a temporally variable temperature distribution on the object surface by imprinting a plurality of chronologically sequential different thermal patterns on the object surface by irradiation with the radiation source with chronologically sequential irradiation pulses, wherein each pulse of the chronologically sequential irradiation pulses is suitable for irradiating one or more surface elements on the object surface, wherein the irradiated one or more surface elements are spatially limited such that an image of each area irradiated by a single pulse of the chronologically sequential irradiation pulses in an image plane of the one or more thermal imaging cameras is smaller than 5% of a total area of the image plane;
detecting of the object surface using the one or more thermal imaging cameras at a plurality of successive recording instants so that a respective sequence of thermal image values is detected for points in the respective image plane of the one or more thermal imaging cameras, and wherein when the object surface is detected by multiple thermal imaging cameras, the detection takes place simultaneously;
identifying mutually corresponding points either in at least one of the image planes of the one or more thermal imaging cameras or in a at least one of a real image plane or a virtual image plane of the device for imprinting thermal patterns, by determining for pairs of potentially corresponding points a similarity between the respective sequence of thermal image values detected for the points of a respective pair or, for points in the real image plane or the virtual image plane associated with the radiation source, determined by simulation, and maximizing the similarity by varying at least one of the points of the respective pair, and
determining one or more spatial coordinates of the object surface by a triangulation based on the identified corresponding points.

11. The apparatus according to claim 10, wherein the device for imprinting thermal patterns and the control and evaluation unit are configured such that the one or more the surface elements irradiated in each pulse of the chronologically sequential irradiation pulses are different and spaced apart from each other such that the one or more surface elements irradiated with individual irradiation pulses are at least one of dot-shaped or line-shaped and are each so small or narrow that, for a dot-shaped surface element, a diameter and, for a line-shaped surface element, a line width of an image of a respective dot-shaped or a respective line-shaped surface element in the image plane of the one or more thermal imaging cameras is smaller than 1/50 of a largest diameter of the image plane.

12. The apparatus according to claim 11, wherein the device for imprinting thermal patterns comprises an optical expansion element, wherein the optical expansion element expands a beam of the radiation source directed to a point on the object surface into a line.

13. The apparatus according to claim 11, further comprising:
a controllable optical deflection device for deflection of the radiation emitted by the radiation source for is configurable to cause a displacement of at least one of a particular point-shaped surface element or a particular line-shaped surface element irradiated by the radiation source.

14. The apparatus according to claim 13, wherein a distance created by the displacement between the surface elements illuminated in immediate succession is such that an image of the distance in the image plane of the one or more thermal imaging cameras is greater than 1/100 of the largest diameter of the image plane.

15. The apparatus according to claim 11, wherein the control and evaluation unit is configured to control the device for imprinting the thermal patterns and the one or more thermal imaging cameras in such a way that at least one of the recording instants lies in a time interval during which the device for imprinting the thermal patterns does not imprint a new thermal pattern.

16. The apparatus according to claim 11, wherein the control and evaluation unit is configured to control the device for imprinting the thermal patterns and the one or more thermal imaging cameras in such a way that at least one of the recording instants is at an instant after the imprinting of a further thermal pattern on the object surface, so that the temperature distribution on the object surface changes between a preceding recording instant and the at least one recording instant by at least one of thermal diffusion or a further energy input by a further irradiation pulse.

17. The apparatus according to claim 11, wherein the control and evaluation unit is configured to identify the similarity between the respective sequences of thermal image values by evaluating a correlation function defined for pairs of sequences of values, and to identify the corresponding points each by maximizing or minimizing a value of a correlation thus formed.

18. The method of claim 1, wherein the detecting is performed by a plurality of thermal imaging cameras, and wherein the detecting takes place simultaneously by each imaging camera of the plurality of imaging cameras such that a respective sequence of thermal image values is detected for points in a respective image plane of each imaging camera.

19. The method of claim 2, wherein the individual surface elements are dot-shaped, and wherein a diameter of an image of the individual surface elements in the image plane of the one or more thermal imaging cameras is smaller than 1/50 of a largest diameter of the image plane.

20. The method of claim 2, wherein the individual surface elements are line-shaped, and wherein a line width of an image of the individual surface elements in the image plane of the one or more thermal imaging cameras is smaller than 1/50 of a largest diameter of the image plane.
